(19) United States
(12) Patent Application Publication
(10) Pub. No.: US 2018/0182295 A1
(43) Pub. Date: Jun. 28, 2018

(54) CURRENT PROGRAMMED PIXEL ARCHITECTURE FOR DISPLAYS

(71) Applicant: INTEL CORPORATION, Santa Clara, CA (US)

(72) Inventors: Khaled Ahmed, Anaheim, CA (US); Prakash K. Radhakrishnan, Portland, OR (US)

(73) Assignee: INTEL CORPORATION, Santa Clara, CA (US)

(21) Appl. No.: 15/387,979

(22) Filed: Dec. 22, 2016

(51) Int. Cl. G09G 3/3241; G09G 3/3266; G09G 3/3283

(52) U.S. Cl. CPC G09G 3/3241; G09G 3/3266; G09G 3/3283; G09G 2300/0809; G09G 2320/0646; G09G 2300/043; G09G 2320/0666

(57) ABSTRACT

In one example, a light-emitting diode display system includes one or more light-emitting diodes and a pixel driver circuit. The pixel driver circuit is to receive an input current, to produce a current that is dependent on the input current, and to provide the produced current to the one or more light-emitting diodes.

### CROSS-REFERENCE TO RELATED APPLICATIONS

This application is related to U.S. patent application Ser. No. ______, filed on even date herewith, titled “Digital Driver for Displays” (Attorney Docket P106422). This application is also related to U.S. patent application Ser. No. ______, filed on even date herewith, titled “Display Driver” (Attorney Docket P106425). This application is also related to U.S. patent application Ser. No. ______, filed on even date herewith, titled “Low Power Dissipation Pixel for Display” (Attorney Docket P106423).

### TECHNICAL FIELD

This disclosure relates generally to pixel driver circuitry for displays (for example, digital or analog driven pixel circuitry for micro light-emitting diode displays).

### BACKGROUND

Displays based on light-emitting diodes (LEDs) such as organic light-emitting diodes (OLEDs) and/or inorganic micro light-emitting diodes (also referred to as micro LEDs or μLEDs) may be used for applications in emerging portable electronics and wearable computers (for example, head mounted displays, head worn displays, wristwatches, wearable watch displays, Virtual Reality displays, Augmented Reality displays, OLED displays, micro LED displays, etc).

### BRIEF DESCRIPTION OF THE DRAWINGS

The following detailed description may be better understood by referencing the accompanying drawings, which contain specific examples of numerous features of the disclosed subject matter.

FIG. 1 illustrates an LED drive pixel circuit;

FIG. 2 illustrates an LED drive pixel circuit;

FIG. 3 illustrates an LED drive pixel circuit;

FIG. 4 illustrates a block diagram of a display pixel driving system;

FIG. 5 illustrates a block diagram of a computing device;

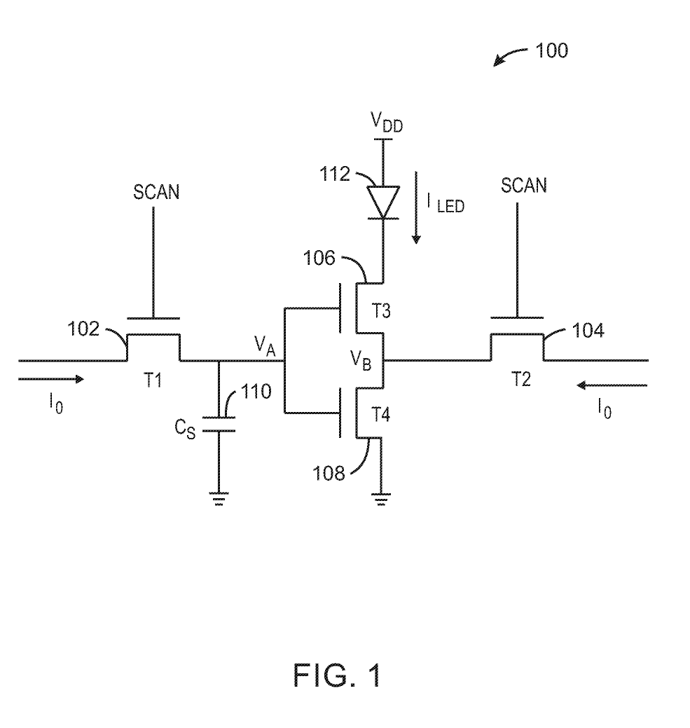

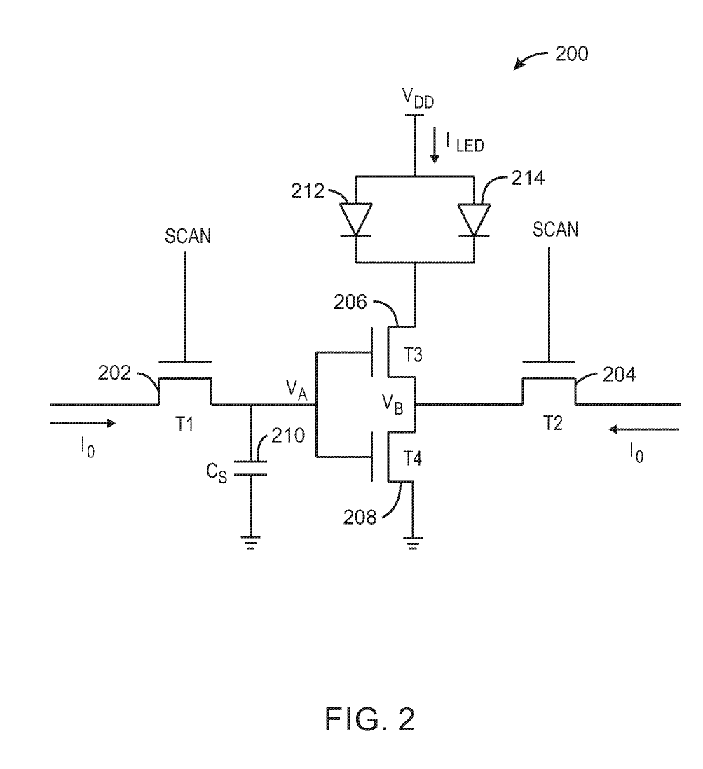

In some cases, the same numbers are used throughout the disclosure and the figures to reference like components and features. In some cases, numbers in the 100 series refer to features originally found in FIG. 1; numbers in the 200 series refer to features originally found in FIG. 2; and so on.

### DESCRIPTION OF THE EMBODIMENTS

Some embodiments relate to displays, mobile displays and/or light-emitting diode (LED) displays.

As described above, displays based LEDs such as organic light-emitting diodes (OLEDs) and/or micro light-emitting diodes (also referred to as micro LEDs or μLEDs) may be beneficial for applications in emerging portable electronics and wearable computers (for example, head mounted displays, head worn displays, wristwatches, wearable watch displays, Virtual Reality displays, Augmented Reality displays, OLED displays, micro LED displays, etc). In view of the typical small size of micro LEDs (for example, in the range of 10 μm or less), the current needed to drive a single micro LED (μLED) for maximum luminance (for example in a range of 30 to 300 nits) can be very low, and may be in the 1 to 100 nA (nanoamp) range. Several challenges can arise in implementing pixel driver circuits for micro LEDs for such low current levels.

It can be difficult for a current-source drive circuit to respond quickly enough to keep up with the display refresh rate when generating the small pixel currents necessary for micro LEDs. Additionally, the width to length (W/L) ratio of the drive transistor (or transistors) might need to shrink by a factor of about 10 to 100 relative to other display drive circuits in order to produce nanoamp-level (nA-level) currents. This is particularly difficult to realize given the dimensions of micro LED pixels and the capabilities of the lithography used in display manufacturing.

In some embodiments, digital driving of display pixels may be used to control gray levels using pulse width modulation (PWM) or pulse density modulation (PDM). Digital driving is compatible with digital video signals, and can help to simplify the system while additionally enhancing display resolution and gray levels. Additionally, in digital driving implementations according to some embodiments, a luminance uniformity of the pixels may not be affected by threshold voltage shifts, since all transistors can work as switches, and all of the pixels can be driven by a uniform power supply current that can drive the light emitting diodes (LEDs) in a manner that the brightness of the pixel can be controlled with a different programming signal.

Some embodiments relate to one or more digitally driven pixel circuits (for example, for mobile displays and/or for LED displays). Some embodiments relate to one or more analog pixel driver circuits (for example, for mobile displays and/or for LED displays). In some embodiments, an analog driver circuit uses a capacitor to hold a voltage and wait for a next signal to update the voltage in an analog fashion.

In some embodiments, digital driving controls gray levels using pulse width modulation (PWM) or using pulse density modulation (PDM). In some embodiments, an input current (for example, an input current I₀) is provided from a control circuit (for example, from outside of the display backplane based on LED characteristics such as μLED characteristics). In some embodiments, a current I₀ is an input current signal supplied (or forced) to the a driver circuit from an external control circuit, which is, for example, outside of the TFT (thin-film-transistor) display backplane based on LED characteristics (for example, based on OLED characteristics and/or micro LED characteristics). In some embodiments, a digital signal (for example, using pulse width modulation or pulse density modulation) controls an average current flowing through one or more LEDs (for example, one or more μLEDs), which controls the average brightness of the one or more LEDs.

In some embodiments, current mirroring is used to mirror current from the input (for example, using on and off current). In some embodiments, the current mirroring is implemented in a digital fashion. In some embodiments, the current mirroring is implemented in an analog fashion.

FIG. 1 is a circuit diagram of an LED digital drive pixel circuit 100. In some embodiments, circuit 100 is a current driver circuit. In some embodiments circuit 100 is a micro LED digital drive pixel circuit. In some embodiments circuit 100 is an organic LED (OLED) digital drive pixel circuit. Circuit 100 includes a transistor T1 102 (for example, an n channel Metal Oxide Semiconductor transistor, or nMOS transistor), a transistor T2 104 (for example, an nMOS transistor), a transistor T3 106 (for example, an nMOS transistor), a transistor T4 108 (for example, an nMOS transistor), and a capacitor C_{S} 110. Circuit 100 additionally includes an LED 112 (for example, in some embodiments a micro LED or in some embodiments an OLED). As illustrated in FIG. 1, in some embodiments some or all of transistors 102, 104, 106, and 108 are nMOS transistors.

In some embodiments, a current I₀ is an input digital current signal supplied (or forced) to circuit 100 from an external control circuit, which is, for example, outside of the TFT (thin-film-transistor) display backplane based on LED characteristics (for example, based on OLED characteristics and/or micro LED characteristics). The current I₀ (for example using Pulse Width Modulation or Pulse Density Modulation), controls the average current I_{LED} flowing through the LED 112, which controls the average brightness of the LED 112. In some embodiments, the I₀ current is converted into the I_{LED} current through a multiplication factor that is dependent on the size of the transistors used in circuit 100.

In some embodiments of circuit 100 in FIG. 1, when the SCAN signal is high (for example, in a programming mode), transistor T3 106 is off, and the data current I₀ passes through transistor T4 108. In some embodiments, transistor T4 108 operates in saturation mode. During the programming phase, the current I₀ passing through transistor T1 102 charges the capacitor C_{S} 110. The current I₀ is the average (DC) value of a pulse train representing the input image signal during the high SCAN pulse, and the capacitor C_{S} 110 is charged and kept at the voltage value V_{A}.

In some embodiments, when the SCAN signal is low (for example, in an emission phase), transistor T3 106 operates in saturation and transistor T4 108 operates in a triode region.

In some embodiments, circuit 100 is a true current driver circuit. In some embodiments, circuit 100 is a true current mirror circuit with a scalable output current (the is, scalable current I_{LED} through the load LED device 112).

FIG. 2 is a circuit diagram of an LED digital drive pixel circuit 200. In some embodiments, circuit 200 is a current driver circuit. In some embodiments circuit 200 is a micro LED digital drive pixel circuit. In some embodiments circuit 200 is an organic LED (OLED) digital drive pixel circuit. Circuit 200 includes a transistor T1 202 (for example, an n channel Metal Oxide Semiconductor transistor, or nMOS transistor), a transistor T2 204 (for example, an nMOS transistor), a transistor T3 206 (for example, an nMOS transistor), a transistor T4 208 (for example, an nMOS transistor), and a capacitor C_{S} 210. Circuit 200 additionally includes an LED 212 (for example, a micro LED or an OLED) and an LED 214 (for example, a micro LED or an OLED). As illustrated in FIG. 2, in some embodiments transistors 202, 204, 206, and 208 are nMOS transistors. In some embodiments, transistors 202, 204, 206, and 208 and capacitor 210 operate the same as, or similarly to transistors 102, 104, 106, and 108, and capacitor 110 of FIG. 1.

In some embodiments, a current I₀ is an input digital current signal supplied (or forced) to circuit 200 from an external control circuit, which is, for example, outside of the TFT (thin-film-transistor) display backplane based on LED characteristics (for example, based on OLED characteristics and/or micro LED characteristics). The current I₀ (for example using Pulse Width Modulation or Pulse Density Modulation), controls the average current I_{LED} flowing through the LEDs 212 and 214, which controls the average brightness of the LEDs 212 and 214. In some embodiments, the I₀ current is converted into the I_{LED} current through a multiplication factor that is dependent on the size of the transistors used in circuit 200.

In some embodiments of circuit 200 in FIG. 2, when the SCAN signal is high (for example, in a programming mode), transistor T3 206 is off, and the data current I₀ passes through transistor T4 208. In some embodiments, transistor T4 208 operates in saturation mode. During the programming phase, the current I₀ passing through transistor T1 202 charges the capacitor C_{S} 210. The current I₀ is the average (DC) value of a pulse train representing the input image signal during the high SCAN pulse, and the capacitor C_{S} 210 is charged and kept at the voltage value VA.

In some embodiments of circuit 200 of FIG. 2, when the SCAN signal is low (for example, in an emission phase), transistor T3 206 operates in saturation and transistor T4 208 operates in a triode region.

In some embodiments, circuit 200 is a true current driver circuit. In some embodiments, circuit 200 is a true current mirror circuit with a scalable output current (the is, scalable current I_{LED} through the load LED devices 212 and 214).

In some embodiments, driver circuit 200 handles multiple LEDs 212 and 214, and drives current to both of those LEDs. In some embodiments, redundant LEDs (such as, for example, micro LEDs or OLEDs) may be implemented. For example, redundant LEDs may be used where those redundant LEDs (such as LEDs 212 and 214) together provide brightness for a single pixel (and/or single color for each pixel) in a display array of pixels (for example, a mobile display array of pixels or an LED display array of pixels). In this manner, redundant LEDs may be used to provide a fault tolerance relating to the LEDs and the current I_{LED} that is driving the LEDs based on the input current I₀. In this manner, if one LED is dead or not working for some reason, the other LED still provides the same amount of luminance that the two LEDs would have provided in parallel. While two redundant LEDs 212 and 214 have been illustrated and described herein, according to some embodiments, one single LED could be used and current driven to that one single LED, and according to some embodiments, more than two LEDs could be used and current driven to those LEDs (for example, using three redundant LEDs, or any other number of redundant LEDs). It is noted that embodiments are not limited to one LED as illustrated in FIG. 1 or to two redundant LEDs as illustrated in FIG. 2.

In some embodiments, a width to length ratio (W/L) of transistor 106 of circuit 100 of FIG. 1 may be adjusted in order to obtain a desired target LED driving current I_{LED}. In some embodiments, a width to length ratio (W/L) of transistor 206 of circuit 200 of FIG. 2 may be adjusted in order to obtain a desired target LED driving current I_{LED}. In some embodiments, a width to length ratio (W/L) of transistor 108 of circuit 100 of FIG. 1 may be adjusted in order to obtain a desired target LED driving current I_{LED}. In some embodiments, a width to length ratio (W/L) of transistor 208 of circuit 200 of FIG. 2 may be adjusted in order to obtain a desired target LED driving current I_{LEO}.

In some embodiments, a width to length ratio (W/L) of transistor 106 and a width to length ratio (W/L) of transistor 108 of circuit 100 of FIG. 1 may both be adjusted in order to obtain a desired target LED driving current I_{LEO}. In some embodiments, a width to length ratio (W/L) of transistor 206 and a width to length ratio (W/L) of transistor 208 of circuit 200 of FIG. 2 may both be adjusted in order to obtain a desired target LED driving current I_{LED}.

In some embodiments, a width to length ratio (W/L) of one or more transistors may be adjusted in order to obtain a desired target LED driving current I_{LED}. For example, different transistor size adjustments may be made for different driver circuits such as, for example, circuit 100 of FIG. 1 and/or circuit 200 of FIG. 2 for circuits in the same pixel driver array of a system (for example, for different LED colors). For example, according to some embodiments, one or more transistor in red LED driver circuits might be one size transistor to optimize the LED driving current I_{LED} for that color, one or more transistor in green LED driver circuits might be another size transistor to optimize the LED driving current I_{LED} for that color, and one or more transistor in blue LED driver circuits might be yet another size transistor to optimize the LED driving current I_{LED} for that color.

In some embodiments, a width to length ratio (W/L) of one or more transistors may be adjusted in order to obtain a desired target supply voltage (for example, supply voltage V_{DD} of circuit 100 of FIG. 2 and/or of circuit 200 of FIG. 2). For example, different transistor size adjustments may be made for different driver circuits such as, for example, circuit 100 of FIG. 1 and/or circuit 200 of FIG. 2 for circuits in the same pixel driver array of a system (for example, for different LED colors). For example, according to some embodiments, one or more transistor in red LED driver circuits might be one size transistor to optimize supply voltage V_{DD} for the driving circuit for that color LED, one or more transistor in green LED driver circuits might be another size transistor to optimize supply voltage V_{DD} for the driving circuit for that color LED, and one or more transistor in blue LED driver circuits might be yet another size transistor to optimize supply voltage V_{DD} for the driving circuit for that color LED.

In some embodiments, the circuit 100 in FIG. 1 (and/or the circuit 200 in FIG. 2) may be implemented using nMOS technology. In some embodiments, transistors 102, 104, 106 and 108 of FIG. 1 and/or transistors 202, 204, 206 and 208 of FIG. 2 may be nMOS transistors. In some embodiments, the circuit 100 in FIG. 1 and/or the circuit 200 in FIG. 2 may be implemented using IGZO (indium gallium zinc oxide) technology (using, for example, IGZO channel thin film transistors). In some embodiments, the circuit 100 in FIG. 1 and/or the circuit 200 in FIG. 2 may be implemented using LTPS (low-temperature polycrystalline silicon) technology (using, for example, LTPS channel thin film transistors).

In some embodiments (for example, some embodiments illustrated in and described in reference to FIG. 1 and/or FIG. 2), current I_{LED} may be calculated based on the following equation:

$${I}_{LED} = \frac{{( W \text{/} L )}_{3}}{{( W \text{/} L )}_{3} + {( W \text{/} L )}_{4}} {I}_{0} \qquad ( EQUATION 1 )$$

Where I_{LED} is the current I_{LED} in FIG. 1 and/or FIG. 2, for example, where (W/L)₃ is the width to length ratio (W/L) of transistor T3 106 and/or of transistor T3 206, (W/L)₄ is the width to length ratio (W/L) of transistor T4 108 and/or of transistor T4 208, and I₀ is the input current I₀ of circuit 100 of FIG. 1 and/or of circuit 200 of FIG. 2.

Equation 1 can be derived as follows:

When the SCAN signal is high (for example, in a programming phase),

V_{GS3}=V_{A}−V_{B}=0 (EQUATION 2)

Where V_{GS3} is the gate-source voltage of transistor T3 106 and/or of transistor T3 206, V_{A} is the voltage at V_{A} in FIG. 1 and/or in FIG. 2, and V_{B} is the voltage at V_{B} in circuit 100 of FIG. 1 and/or in circuit 200 of FIG. 2.

Thus, transistor T3 106 and/or transistor T3 206 is OFF, and the data current I₀ passes through transistor T4 108 and/or transistor T4 208.

If transistor T4 108 and/or transistor T4 208 operates in saturation (in some embodiments, conditions of circuit 100 and/or circuit 200 are provided to guarantee that transistor T4 108 and/or transistor T4 208 does operate in saturation), then:

I₀=I₄=½μk₄(V_{A}−V_{T}−0)² (EQUATION 3)

Where I₄ is the current flowing through transistor T4 108 and/or transistor T4 208, μ is the mobility of electrons in the transistor channel, k₄ is the width to length ratio of transistor T4 108 and/or transistor T4 208, that is, k₄ is equal to (W/L)₄, and V_{T} is the threshold voltage of all transistors in the circuit.

Thus, the following equation is derived:

$${V}_{A} = {V}_{T} + \sqrt{\frac{2 {I}_{0}}{{k}_{4} μ}} \qquad ( EQUATION 4 )$$

During the programming phase, the current I₀ passing through transistor T1 102 and/or transistor T1 202 charges the capacitor C_{S} 110 and/or capacitor C_{S} 210 given by EQUATION 4. The current I₀ in circuit 100 and/or in circuit 200 is the average (DC) value of a pulse train representing the input image signal during the phase where SCAN is high.

For purposes of this derivation, x is defined according to the following equation 5:

$$\begin{matrix}x = \sqrt{\frac{2 {I}_{0}}{{k}_{4} μ}} \\ Thus \text{:} & ( EQUATION 5 ) \\ {V}_{A} = {V}_{T} + x & ( EQUATION 6 )\end{matrix}$$

During the phase where the SCAN pulse signal is high, the capacitor C_{S} 110 and/or the capacitor C_{S} 210 is charged and kept at the voltage value V_{A} given in EQUATION 4. When the SCAN pulse signal is low (for example, during an emission phase), transistor T3 106 and/or transistor T3 206 operates in saturation and transistor T4 108 and/or transistor T4 208 operates in a triode region, and the following equation is derived:

I_{LED}=I₃−I₄ (EQUATION 7)

Where I₃ is the current flowing through transistor T3 106 and/or through transistor T3 206.

Thus:

½μk₃(V_{A}−V_{T}−V_{B})²=μk₄ [(V_{A}−V_{T}−0)V_{B}−½V_{B}²] (EQUATION 8)

Where k₃ is the width to length ratio of transistor T3 106 and/or the width to length ratio of transistor T3 206. That is, k₃ is equal to (W/L)₃.

Solving the above equations for V_{B}, the following equation becomes:

$$\begin{matrix} {V}_{B} = x \pm x \sqrt{\frac{{k}_{3}}{{k}_{3} + {k}_{4}}} \\ Therefore \text{:} & ( EQUATION 9 ) \\ {I}_{LED} = \frac{1}{2} μ {k}_{3} {( {V}_{A} - {V}_{T} - {V}_{B} )}^{2} = \frac{1}{2} μ {k}_{3} {( {V}_{T} + x - {V}_{T} - {V}_{B} )}^{2} = \frac{1}{2} μ {k}_{3} {( x - {V}_{B} )}^{2} & ( EQUATION 10 )\end{matrix}$$

Substituting for V_{B} using equation 9, we can find:

$${I}_{LED} = \frac{{k}_{3}}{{k}_{3} + {k}_{4}} {I}_{0} \qquad ( EQUATION 11 )$$

Substituting the dimensions of the transistors T3 206 and T4 208, equation 11 becomes:

$${I}_{LED} = \frac{{( W \text{/} L )}_{3}}{{( W \text{/} L )}_{3} + {( W \text{/} L )}_{4}} {I}_{0} \qquad ( EQUATION 12 )$$

Additionally, in some embodiments, needed values of (and/or optimal values of) the supply voltage (for example, supply voltage V_{DD} of circuit 100 of FIG. 1 and/or supply voltage V_{DD} of circuit 200 of FIG. 2) may be derived as follows:

In order for transistor T4 108 and/or for transistor T4 208 to operate in triode region, the following condition should be satisfied:

V_{B}<V_{GS4}−V_{T} (EQUATION 13)

Where V_{GS4} is the gate-source voltage of transistor T4 108 and/or the gate-source voltage of transistor T4 208, and V_{T} is the threshold voltage of all transistors in the circuit 100 and/or in the circuit 200.

We can find:

V_{GS4}−V_{A}−V_{T} (EQUATION 14)

Using equations 14, 4, 5 and 13, the following equation can be derived:

V_{B}<x (EQUATION 15)

Equation 15 and 9 lead to the following:

$${V}_{B} = x - x \sqrt{\frac{{k}_{3}}{{k}_{3} + {k}_{4}}} \qquad ( EQUATION 16 )$$

In order for transistor T3 106 and/or transistor T3 206 to operate in a saturation region, the following inequality is satisfied:

V_{DS3}>V_{GS3}−V_{T} (EQUATION 17)

Thus:

V_{DD}−V_{LED}−V_{B}>V_{A}−V_{B}−V_{T} (EQUATION 18)

Using equations 4, 16, and 18, the following supply voltage V_{DD} can be derived:

$${V}_{DD} > {V}_{LED} + \sqrt{\frac{2 {I}_{0}}{{( W \text{/} L )}_{4} {C}_{ox} μ}} \qquad ( EQUATION 19 )$$

Where V_{LED} is the turn on voltage of one or more LEDs being driven (for example, the turn on voltage of LED 112, and/or the turn on voltage of LEDs 212 and 214, and/or the turn on voltage of a number of LEDs such as a number of redundant parallel LEDs in some embodiments); and where Cₒₓ is the gate oxide capacitance (or capacitance of the oxide layer) of the transistors in the circuit. It is noted that in some embodiments, all transistors in the circuit (for example, in the circuit 100 and/or in the circuit 200) have similar gate oxide capacitance (and/or the same gate oxide capacitance within a tolerance) and/or similar gate oxide thickness (and/or the same gate oxide thickness within a tolerance).

In some embodiments, different LEDs have different turn on voltages, and the driving circuit supply voltage may be adjusted accordingly (for example, by varying a size of one or more transistors in the driving circuit). In some embodiments, for example, for one or more LEDs, the turn on voltage V_{LED} can be a maximum of 3 volts (for example, in some embodiments V_{LED} can be approximately 2.9 volts, and the “additional component” of

$$\sqrt{\frac{2 {I}_{0}}{{( W \text{/} L )}_{4} {C}_{ox} μ}}$$

in EQUATION 19 can be around 0.4 volts for a total supply voltage V_{DD} of around 3.3v or more. This can be much smaller than the supply voltage that has previously been used for driving organic LEDs, which can be around 7 volts. A lower supply voltage according to some embodiments can allow significant power savings, particularly when multiplied over many pixels of different locations and colors in a display array.

For example, in some embodiments, the turn on voltage V_{LED} for a blue LED is:

V_{LED,blue}≈2.9 V (EQUATION 20)

For some embodiments using indium gallium zinc oxide (IGZO) channel thin film transistors (TFTs), I₀=1 μA, (W/L)₄=2, Cₒₓ=0.1 μF/cm², and μ=10 cm²/V−s. Therefore, according to some embodiments, the supply voltage V_{DD} could be calculated to be:

V_{DD,IGZO}>3.9 V (EQUATION 21)

For some embodiments using low-temperature polycrystalline silicon (LTPS) channel thin film transistors (TFTs), I₀=1 μA, (W/L)₄=2, Cₒₓ=0.1 μF/cm², and μ=50 cm²/V−s. Therefore, according to some embodiments, V_{DD} could be calculated to be:

V_{DD,LTPS}>3.3 V (EQUATION 22)

In some embodiments, digital pixel driving circuit 100 and/or digital pixel driving circuit 200 are implemented using nMOS technology (for example, using nMOS devices, nMOS transistors, etc.). In some embodiments, digital pixel driving circuit 100 and/or digital pixel driving circuit 200 are implemented using low-temperature polycrystalline silicon (LTPS) channel thin film transistors (TFTs). In some embodiments, digital pixel driving circuit 100 and/or digital pixel driving circuit 200 are implemented using indium gallium zinc oxide (IGZO) channel thin film transistors (TFTs).

In some embodiments, the LED current I_{LED} (for example, the LED current I_{LED} of circuit 100 of FIG. 1 and/or of circuit 200 of FIG. 2) is smaller than the input current (or bias current) I₀. This allows the circuit to receive a very large current I₀, and scale that current down to a specific relatively small LED current (for example, a current in the nanoamp range). This can provide an advantage over other circuits due to the scaling factor, allowing low power usage and other advantages while still maintaining circuit speed and quick settling times due to the larger input current.

In some embodiments (for example, in some embodiments of the circuit 100 of FIG. 1 and/or in the circuit 200 of FIG. 2), the current I_{LED} flowing through one or more LEDs (for example, the current I_{LED} flowing through LED 112 and/or the current I_{LED} flowing through LEDs 212 and 214) is proportional to the input current (for example, the input current I₀). In some embodiments, more than one LED is provided in parallel in a redundant fashion (for example, LEDs 212 and 214 of FIG. 2). In this manner, the input current I₀ is propagated and spread to a current I_{LED} that flows to the redundant LEDs (for example, LEDs 212 and 214). In some embodiments, if one of the LEDs is not working for some reason, the entire current I_{LED} will flow through the other LED that is still working (for example, due to a manufacturing defect in one of the LEDs or other loss of an LED). If all redundant LEDs are working (for example, both LEDs 212 and 214 are working), a proportional amount of the current I_{LED} will flow through each of the redundant LEDs (for example, in some embodiments, half of the current I_{LED} will flow through LED 212 and the other half of the current I_{LED} will flow through the LED 214). In each of these situations, the luminance of the redundant LEDs is the same. For example, if current I_{LED} is flowing through only one of the LEDs 212 and 214 because the other LED is not working for some reason, the luminance of the working LED will be the same as the total luminance of both LEDs in a situation where both LEDs are working, and half of the driving current (I_{LED}/2) is flowing through one of the LEDs and half of the driving current (I_{LED}/2) is flowing through the other LED. Therefore, the visual appearance in each of these situations to a viewer of the display will be the same whether all LEDs are working or if one is not working. Similarly, in an embodiment where three LEDs are in parallel and one LED is not working, half the current I_{LED} will flow through each of the working LEDs, and in an embodiment where more LEDs are in parallel and one or more LED is not working, a proportional current I_{LED} will flow through each of the working LEDs. A target brightness including luminance of all working LEDs is the same in each situation. The current I_{LED} is passed through the LEDs in such a way that the same luminance is provided when an LED goes out for any reason (and/or is dead upon manufacture thereof).

In some embodiments, a width to length ratio (W/L) of one or more transistors in an LED current driving circuit may be adjusted in order to obtain a desired target LED driving current.

In some embodiments, a circuit may be used to control current through one or more LEDs (for example, OLEDs and/or micro LEDs) using:
a very low current passed through the LEDs (for example, OLEDs and/or micro LEDs) using an input current that is large enough to improve circuit speed;
all transistors in the circuit operating in a strong inversion operating region, which is more stable and less vulnerable to variability;
a self-compensated circuit with regard to threshold voltage variation (for example, due to process variations and/or due to transistor instability);
a true digital current driving circuit without having long settling time issues; and/or
multiple ways (or knobs) to control LED current (for example, micro LED current) in the nano-ampere (nA) level without sacrificing speed (for example, settling times) or display quality.

In some embodiments, an input current (and/or bias current such as current I₀) is pulsed and provided as an input to an LED current driving circuit. In some embodiments, an input current (and/or bias current such as current I₀) is scaled based on device sizes down to a smaller LED current (for example, current I_{LED}). In some embodiments, a voltage supply (for example, supply voltage V_{DD}) can be as small as the turn off voltage of the LED or LEDs (V_{LED}), and/or as small as the turn off voltage of the LED(s) plus a small offset voltage.

In some embodiments, the current driving one or more LEDs (for example, in some embodiments, I_{LED}) has a linear dependence on the input current (for example, in some embodiments, I₀). In some embodiments, the current driving one or more LEDs (for example, in some embodiments, I_{LED}) is proportional to the input current (for example, in some embodiments, I₀).

In some embodiments, low power consumption may be enabled. In this manner, in some embodiments, a good user experience may be obtained through low power consumption, leading to thin displays and/or long battery life at a low cost.

In some embodiments, different size transistors are used for different circuits driving current for different colored LEDs (for example, due to different currents needed to drive different colored LEDs). In some embodiments, different supply voltages are used for different colored LEDs (for example, due to different supply voltages needed for different colored LEDs). For example, in some embodiments, different size circuit elements (for example, different size width to length ratios of transistors) may be used to provide different LED currents based on the color of the LED or LEDs in that particular circuit. According to some embodiments, the current flowing through the LED(s) can be changed by changing the size of transistors in the circuit. This can be very favorable in a display array (for example, in a mobile display array and/or an LED display array).

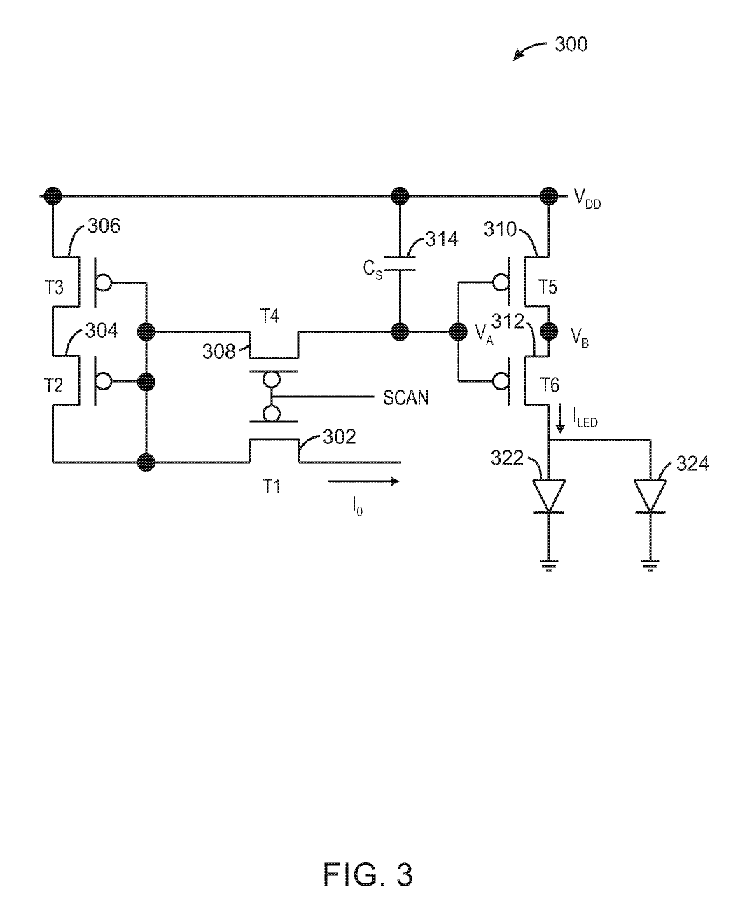

FIG. 3 is a circuit diagram of an LED digital drive pixel circuit 300. In some embodiments, circuit 300 is a current driver circuit. In some embodiments, circuit 300 is a digital current driver circuit. In some embodiments, circuit 300 is an analog current driver circuit. In some embodiments circuit 300 is a micro LED digital drive pixel circuit. In some embodiments circuit 300 is an organic LED (OLED) digital drive pixel circuit. Circuit 300 includes a transistor T1 302 (for example, a p channel Metal Oxide Semiconductor transistor, or pMOS transistor), a transistor T2 304 (for example, a pMOS transistor), a transistor T3 306 (for example, a pMOS transistor), a transistor T4 308 (for example, a pMOS transistor), a transistor T5 310 (for example, a pMOS transistor), a transistor T6 312 (for example, a pMOS transistor), and a capacitor C_{S} 314. Circuit 300 additionally includes an LED 322 (for example, in some embodiments a micro LED or in some embodiments an OLED) and an LED 324 (for example, in some embodiments a micro LED or in some embodiments an OLED). As illustrated in FIG. 3, in some embodiments some or all of transistors 302, 304, 306, 308, 310 and 312 are pMOS transistors.

In some embodiments, current I₀ is an input digital current signal supplied (or forced) to circuit 300 from a driver circuit (for example, a driver integrated circuit external from circuit 300). In some embodiments, current I₀ is an input digital current signal supplied (or forced) to circuit 300 from an external control circuit, which is, for example, outside of the TFT (thin-film-transistor) display backplane based on LED characteristics (for example, based on OLED characteristics and/or micro LED characteristics). The current I₀ (for example using Pulse Width Modulation or Pulse Density Modulation), controls the average current I_{LED} flowing through the LEDs 322 and/or 324, which controls the average brightness of the LEDs 322 and/or 324. In some embodiments, the I₀ current is converted into the I_{LED} current through a multiplication factor that is dependent on the size of the transistors used in circuit 300.

In some embodiments, driver circuit 300 handles multiple LEDs 322 and 324, and drives current to both of those LEDs. In some embodiments, redundant LEDs (such as, for example, micro LEDs or OLEDs) may be implemented. For example, redundant LEDs may be used where those redundant LEDs (such as LEDs 322 and 324) together provide brightness for a single pixel (and/or single color for each pixel) in a display array of pixels (for example, a mobile display array of pixels and/or an LED display array of pixels). In this manner, redundant LEDs may be used to provide a fault tolerance relating to the LEDs and the current I_{LED} that is driving the LEDs based on the input current I₀. In this manner, if one LED is dead or not working for some reason, the other LED still provides the same amount of luminance that the two LEDs would have provided in parallel. While two redundant LEDs 322 and 324 have been illustrated and described herein, according to some embodiments, one single LED could be used and current driven to that one single LED, and according to some embodiments, more than two LEDs could be used and current driven to those LEDs (for example, using three redundant LEDs, or any other number of redundant LEDs). It is noted that embodiments are not limited to two redundant LEDs as illustrated in FIG. 3.

In some embodiments, one or more of the transistors in circuit 300 are thin film transistors (TFTs). In some embodiments, circuit 300 is implemented using pMOS technology (for example, using pMOS transistors). In some embodiments, circuit 300 may be implemented using LTPS (low-temperature polycrystalline silicon) technology (using, for example, LTPS channel thin film transistors).

In some embodiments, in a programming phase of circuit 300, when the SCAN pulse goes low, transistor T1 302 and transistor T4 308 turn on. Capacitor C_{S} 314 charges as current I₀ flows through transistor T1 302 and transistor T4 308. In steady state, according to some embodiments, the current flowing through transistor T2 304 and transistor T3 306 is equal.

In some embodiments, if transistor T3 306 operates in a saturation region, the following equation will apply:

I₀=I₃=½μk₃(V_{A}−V_{DD}−V_{T})² (EQUATION 23)

Where I₀ is the input current I₀ of circuit 300 of FIG. 3, I₃ is the current flowing through transistor T3 306, μ is the mobility of electrons in the transistor channel, k₃ is the width to length ratio of transistor T3 306, V_{A} is the voltage at point V_{A} in FIG. 3, V_{DD} is the supply voltage V_{DD} (for example, voltage VDD in FIG. 3), and V_{T} is a threshold voltage of all transistors in the circuit (for example, in circuit 300).

Equation 23 can be used to derive the following, solving for voltage potential V_{A}:

$${V}_{A} = {V}_{DD} + {V}_{T} - \sqrt{\frac{2 {I}_{0}}{{k}_{3} μ}} \qquad ( EQUATION 24 )$$

X is defined as:

$$\begin{matrix}x = \sqrt{\frac{2 {I}_{0}}{{k}_{3} μ}} \\ Therefore \text{:} & ( EQUATION 25 ) \\ {V}_{A} = {V}_{DD} + {V}_{T} - x & ( EQUATION 26 )\end{matrix}$$

During the SCAN pulse where SCAN is a low value, the capacitor C_{S} 314 is charged and kept at the value V_{A} represented by EQUATION 24 and EQUATION 26.

During an emission phase of circuit 300, when the SCAN pulse is at a high value, transistor T1 302 and transistor T4 308 turn off, and the current through transistor T5 310 and the current through transistor T6 312 is determined by the voltage V_{A} from EQUATIONS 24 and 26. When transistor T6 312 operates in a saturation region and transistor T5 310 operates in a triode region, the following is true:

I_{LED}=I₅=I₆ (EQUATION 27)

Where I_{LED} is the current I_{LED} flowing to the parallel LEDs 322 and 324 in circuit 300, I₅ is the current flowing through transistor T5 310, and I₆ is the current flowing through transistor T6 312.

Therefore:

½μk₆(V_{A}−V_{T}−V_{B})²=μk₅ [(V_{A}−V_{T}−V_{DD})(V_{B}−V_{DD})−½(V_{B}−V_{DD})²] (EQUATION 28)

Where k₆ is a width to length ratio of transistor T6 312, k₅ is a width to length ratio of transistor T5 310, and V_{B} is a voltage at point V_{B} in circuit 300 of FIG. 3.

Using the above equations, the following is true:

$${V}_{B} - {V}_{DD} = x \pm x \sqrt{\frac{{k}_{5}}{{k}_{5} + {k}_{6}}} \qquad ( EQUATION 29 )$$

Using the above equations, the LED current I_{LED} in FIG. 3 can be calculated as follows:

$${I}_{LED} = \frac{1}{2} μ {k}_{6} {( {V}_{A} - {V}_{T} - {V}_{B} )}^{2} = \frac{1}{2} μ {k}_{6} {( {V}_{DD} + {V}_{T} - x - {V}_{T} - {V}_{DD} - x \pm x \sqrt{\frac{{k}_{5}}{{k}_{5} + {k}_{6}}} )}^{2} \qquad ( EQUATION 30 )$$

Using Equations 25 and 30, the LED current I_{LED} is simplified as:

$${I}_{LED} = \frac{{k}_{6}}{{k}_{3}} {( 2 + \sqrt{\frac{{k}_{5}}{{k}_{5} + {k}_{6}}} )}^{2} {I}_{0} \qquad ( EQUATION 31 )$$

Therefore, in some embodiments a current I_{LED} supplied to one or more LEDs (for example, LED current I_{LED} supplied to LEDs 322 and 324 of circuit 300) is dependent on an input current I₀ and/or on a size of one or more transistors in the circuit (for example, based on a width to length ratio of one or more transistors in the circuit). In some embodiments, a current I_{LED} supplied to one or more LEDs (for example, LED current I_{LED} supplied to LEDs 322 and 324 of circuit 300) is dependent on an input current I₀ and/or on a size of transistor T3 306, a size of transistor T5 310, and/or a size of transistor T6 312 in the circuit 300 (for example, based on a width to length ratio of transistor T3 306, a width to length ratio of transistor T5 310, and/or a width to length ratio of transistor T6 312).

In some embodiments, current I_{LED} is determined when circuit 300 is designed. For example, in some embodiments a different current I_{LED} is desired depending on whether the LED(s) in circuit 300 are red, green, or blue (for example, depending on whether circuit 300 is to be used as a driver circuit for one or more red, green, or blue LEDs). In some embodiments, the width to length ratios of transistors in circuit 300 are designed according to Equation 31.

According to some embodiments, a certain supply voltage V_{DD} of circuit 300 may need to be used in order for the LED current I_{LED} to behave according to the equations described above. In some embodiments, in order for transistor T5 310 to operate in a triode region (as assumed in some of the equations leading to derivation of the LED current I_{LED} as described above), the following condition should be satisfied:

V_{B}−V_{DD}<V_{GS5}−V_{T} (EQUATION 32)

Where V_{GS5} is a gate to source voltage of transistor T5 310.

Using equations such as Equation 26 and Equation 32, results in:

V_{GS5}−V_{A}−V_{DD}−V_{T}+x (EQUATION 33)

Using Equations 25, 32 and 33 results in:

V_{B}−V_{DD}<x (EQUATION 34)

Equations 29 and 34 lead to:

$${V}_{B} = {V}_{DD} + x - x \sqrt{\frac{{k}_{5}}{{k}_{5} + {k}_{6}}} \qquad ( EQUATION 35 )$$

In some embodiments, in order for transistor T6 312 to operate in a saturation region, the following inequality should be satisfied:

V_{DS6}>V_{GS6}−V_{T} (EQUATION 36)

Where V_{DS6} is a drain to source voltage of transistor T6 312 and V_{GS6} is a gate to source voltage of transistor T6 312.

Therefore:

V_{LED}−V_{B}>V_{A}−V_{B}−V_{T} (EQUATION 37)

Where V_{LED} is an LED voltage (or LED turn on voltage) at the point between transistor T6 312 and the LEDs 322 and 324.

Using Equation 25 and Equation 37, the following condition on the supply voltage V_{DD} is determined:

$${V}_{DD} < {V}_{LED} + \sqrt{\frac{2 {I}_{0}}{{( W \text{/} L )}_{3} {C}_{ox} μ}} \qquad ( EQUATION 38 )$$

Where (W/L)₃ is equal to k₃, and represents the width to length ratio of transistor T3 306, and Cₒₓ is the gate oxide capacitance (or capacitance of the oxide layer) of the transistors in circuit 300.

For a red LED, the V_{LED} turn on voltage is:

V_{LED,red}≈1.9 V (EQUATION 39)

For low-temperature polycrystalline silicon (LTPS) channel thin film transistors (TFTs), for example, according to some embodiments, I₀=1 μA, (W/L)₃=2, Cₒₓ=0.1 μF/cm², and μ=50 cm²/V−s. Using Equations 38 and 39, in some embodiments, for a red LED the following supply voltage V_{DD} needed for some embodiments of circuit 300 is:

V_{DD}<2 V (EQUATION 40)

In some embodiments, similar calculations using V_{LED} turn on voltages for blue and green LEDs in conjunction with EQUATION 38 to determine a supply voltage of less than 3 volts for a blue LED pixel driving circuit such as circuit 300 and less than 2.5 volts for a green LED pixel driving circuit such as circuit 300. Since in some embodiments, a supply voltage V_{DD} is less than 2 V for red LED circuits, a supply voltage V_{DD} less than 3 V for blue LED circuits, and a supply voltage V_{DD} less than 2.5 V for green LED circuits, to set conditions for all three RGB circuits in a display pixel driver system, a supply voltage V_{DD} less than 2 V can be used according to some embodiments for all circuits (that is, for all red, green and blue pixel driver circuits). In some embodiments, a supply voltage V_{DD} of less than 2 V may be used for red LED circuits, a supply voltage V_{DD} of less than 3 V may be used for blue LED circuits, and a supply voltage V_{DD} of less than 2.5 V may be used for green LED circuits in a display pixel driver system. In embodiments where different supply voltages V_{DD} are used for different pixel driver circuits (for example, different supply voltages V_{DD} for each of red, blue and green LED pixel driver circuits) different circuits would need to be designed for each of the different circuits, with for example, different V_{DD} supply voltage values.

In some embodiments, some transistors in circuit 300 work in a triode region, and/or some transistors in circuit 300 work in a saturation region. In some embodiments (for example, as described according to some of the equations above) the supply voltage V_{DD} is provided at a voltage level such that transistors in the circuit (for example, transistors in circuit 300) work in a manner to satisfy certain conditions (such as, for example, conditions of equations such as Equations 31 and 38). In some embodiments, the supply voltage V_{DD} and/or an input current I₀ are provided in a manner that provide a scalable output current (for example, LED current I_{LED} to or through LED devices in an LED pixel driver circuit 300. In some embodiments, circuit 300 provides LED current I_{LED} that is proportional to an input current I₀. In some embodiments, circuit 300 provides LED current I_{LED} that is dependent on a size of one or more transistors in the circuit. In some embodiments, circuit 300 provides LED current I_{LED} that is dependent on a width to length ratio of one or more transistors in the circuit.

In some embodiments, all transistors in circuit 300 have the same threshold voltage V_{T}, the same gate oxide capacitance Cₒₓ, and/or the same mobility μ. In some embodiments, transistors with different width to length ratios (W/L or k values) can be used for different LED color pixel driver circuits. For example, in some embodiments, a first width to length ratio is used for some or all transistors in some or all red LED pixel driver circuits 300, a second width to length ratio is used for some or all transistors in some or all blue LED pixel driver circuits 300, and a third width to length ratio is used for some or all transistors in some or all green LED pixel driver circuits 300.

As discussed herein, in some embodiments LEDs 322 and 324 (and/or other LEDs in some embodiments) can be μLEDs, and in some embodiments LEDs 322 and 324 (and/or other LEDs in some embodiments) can be OLEDs.

In some embodiments, one current source per pixel can be provided by an external circuit, and the current for red, green, and blue LEDs (for example, red, green and blue OLEDs or red, green and blue μLEDs) can be set by designing a size of transistors in circuit 300 (for example, by designing width to length ratios of one or more transistors in circuit 300).

In some embodiments, a very low current (for example, current I_{LED}) can be passed to LEDs in circuit 300, but the input current I₀ can still be large enough to improve circuit speed.

In some embodiments, all transistors in circuit 300 can operate in a strong inversion operating mode (and/or a strong inversion operating region) that can be stable and have a low vulnerability to variability.

In some embodiments, circuit 300 is a self-compensated circuit relative to threshold voltage variations that might be caused, for example, due to process variations and/or transistor instability.

In some embodiments, circuit 300 can provide digital current driving without long settling times. In some embodiments, circuit 300 can provide analog current driving without long settling times.

In some embodiments, circuit 300 can provide multiple ways to control LED current (for example, to control μLED current) at a nano ampere level without sacrificing speed (for example, settling times) or display quality.

In some embodiments, circuit 300 is an analog driver circuit that uses capacitor C_{S} 314 to hold the voltage at point V_{A} and wait for the next signal to come and update the voltage. The voltage held in capacitor C_{S} 314 is the difference between voltage V_{DD} and voltage V_{A} and is held until the next signal arrives at the circuit 300. Capacitor C_{S} 314 is used according to some embodiments to drive the current I_{LED} in an analog fashion based on the input current I₀. Analog driving according to some embodiments can allow the circuit 300 to work at a low frequency. In some embodiments, circuit 300 allows mirroring the current (which is on and off current) from the input, and the current I_{LED} to the LEDs 322 and 324 is provided in an analog manner.

In some embodiments, use of pMOS devices in circuit 300 can allow the LEDs 322 and 324 to be grounded. That is, in some embodiments, the LEDs 322 and 324 each have a terminal that is coupled to a ground voltage. In this manner, the LEDs 322 and 324 can have a common cathode during the fabrication process of the LEDs. Additionally, in some embodiments, current I_{LED} is allowed to sink to the ground.

In some embodiments, the current I_{LED} in circuit 300 is proportional to the input current I₀ by a factor. The factor can be designed using transistor sizes (that is, for example, using width to length ratios of the transistors).

In some embodiments, a current mirror with a scalable output current is provided (for example, a scalable output load current such as current I_{LED} show in circuit 100, circuit 200, circuit 300, etc.) Current mirrors can be used to provide current programming pixels to compensate for current non-uniformities in active matrix flat panel display arrays (for example, such as active matrix LED or AMLED display arrays). According to some embodiments, for example, using μLED arrays, a large pixel charging time due to a small pixel current (for example, in a 1-100 nA range) can be reduced by providing a large data current (for example, current I₀) that exceeds a desired LED current. According to some embodiments, a large input current is provided and a current mirror is used to transfer a low current (for example, current I_{LED}) to an LED load.

In some embodiments, current provided to one or more LEDs (for example, current I_{LED}) is controlled using a small width to length ratio for transistors (which can result in a small area being used), and/or can also be controlled using a relatively large bias current (for example, current I₀) such as, for example, a bias current in a range of around 10 to 20 micro A (which can result in an ultrashort settling time).

In some embodiments, a driver circuit (for example, such as driver circuit 100, driver circuit 200, driver circuit 300, etc.) is provided for each pixel in a display. For example, a display with 400 lines and 400 columns could include 160,000 driver circuits times the number of colors. For example, in some embodiments there are three colors in a red green blue (or RGB) system, and there could be 480,000 driver circuits (and 960,000 LEDs since there are two LEDs per circuit) for the 400×400 display (160,000 times 3, since each color would have a separate driver circuit for each of the pixels in the array).

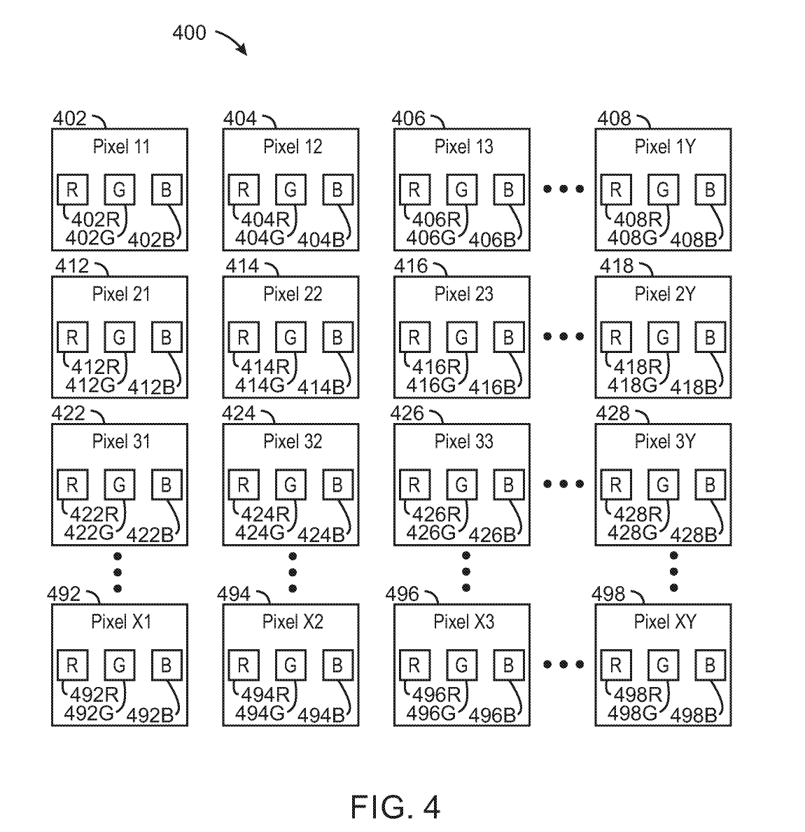

FIG. 4 illustrates a display pixel driver system 400 (for example, a mobile display pixel driver system, an OLED pixel driver system, and/or a micro LED pixel driver system). Pixel driver system 400 displays pixels in X rows and Y columns. In some embodiments, pixel driver system 400 displays pixels in 400 rows and 400 columns. Each pixel in the system 400 includes a number of driver circuits. For example, as illustrated in FIG. 4, each pixel includes a driver circuit for each of a number of colors in the driver system (for example, as illustrated in FIG. 4, a separate pixel driver circuit for each of red (R), blue (B), and green (G) pixels. FIG. 4 illustrates Y pixels in each row. Row 1 includes pixel 11 (402) with a red pixel driver circuit 402R, a green pixel driver circuit 402G and a blue pixel driver circuit 402B, pixel 12 (404) with a red pixel driver circuit 404R, a green pixel driver circuit 404G and a blue pixel driver circuit 404B, pixel 13 (406) with a red pixel driver circuit 406R, a green pixel driver circuit 406G and a blue pixel driver circuit 406B, pixel 1Y (408) with a red pixel driver circuit 408R, a green pixel driver circuit 408G and a blue pixel driver circuit 408B. Row 2 includes pixel 21 (412) with a red pixel driver circuit 412R, a green pixel driver circuit 412G and a blue pixel driver circuit 412B, pixel 22 (414) with a red pixel driver circuit 414R, a green pixel driver circuit 414G and a blue pixel driver circuit 414B, pixel 23 (416) with a red pixel driver circuit 416R, a green pixel driver circuit 416G and a blue pixel driver circuit 416B, . . . , pixel 2Y (418) with a red pixel driver circuit 418R, a green pixel driver circuit 418G and a blue pixel driver circuit 418B. Row 3 includes pixel 31 (422) with a red pixel driver circuit 422R, a green pixel driver circuit 422G and a blue pixel driver circuit 422B, pixel 32 (424) with a red pixel driver circuit 424R, a green pixel driver circuit 424G and a blue pixel driver circuit 424B, pixel 33 (426) with a red pixel driver circuit 426R, a green pixel driver circuit 426G and a blue pixel driver circuit 426B, pixel 3Y (428) with a red pixel driver circuit 428R, a green pixel driver circuit 428G and a blue pixel driver circuit 428B. Row X includes pixel X1 (492) with a red pixel driver circuit 492R, a green pixel driver circuit 492G and a blue pixel driver circuit 492B, pixel X2 (494) with a red pixel driver circuit 494R, a green pixel driver circuit 494G and a blue pixel driver circuit 494B, pixel X3 (496) with a red pixel driver circuit 496R, a green pixel driver circuit 496G and a blue pixel driver circuit 496B, pixel XY (498) with a red pixel driver circuit 498R, a green pixel driver circuit 498G and a blue pixel driver circuit 498B.

In some embodiments, one or more of the pixel driver circuits in the system 400 (for example, circuits 402R, 402G, 402B, 404R, 404G, 404B, 406R, 406G, 406B, . . . , 408R, 408G, 408B, 412R, 412G, 412B, 414R, 414G, 414B, 416R, 416G, 416B, . . . , 418R, 418G, 418B, 422R, 422G, 422B, 424R, 424G, 424B, 426R, 426G, 426B, . . . , 428R, 428G, 428B, 492R, 492G, 492B, 494R, 494G, 494B, 496R, 496G, 496B, . . . , 498R, 498G, 498B) may be implemented using one or more of the circuits 100, 200 or 300 described herein. In some embodiments, each of the pixel driver circuits in the system 400 (for example, circuits 402R, 402G, 402B, 404R, 404G, 404B, 406R, 406G, 406B, . . . , 408R, 408G, 408B, 412R, 412G, 412B, 414R, 414G, 414B, 416R, 416G, 416B, . . . , 418R, 418G, 418B, 422R, 422G, 422B, 424R, 424G, 424B, 426R, 426G, 426B, . . . , 428R, 428G, 428B, 492R, 492G, 492B, 494R, 494G, 494B, 496R, 496G, 496B, . . . , 498R, 498G, 498B) may be implemented using one or more of the circuits 100, 200 or 300 described herein.

In some embodiments of FIG. 4, a driver circuit (for example, such as driver circuit 100 of FIG. 1, driver circuit 200 of FIG. 2, and/or driver circuit 300 of FIG. 3) is provided for one or more pixel (or each pixel) in a display. For example, a display with 400 lines and 400 columns can include 160,000 driver circuits times the number of colors. For example, in some embodiments there are three colors in a red green blue (or RGB) system, and 480,000 driver circuits (and in some embodiments, 960,000 LEDs, with two redundant LEDs per driver circuit) for the 400×400 display (160,000 times 3, since each color has a separate driver circuit for each of the pixels in the array).

In some embodiments, a self-compensated circuit is provided with regard to threshold variation (for example, due to process variations, transistor instability, etc). In some embodiments, a true digital current driving circuit may be implemented without long settling time issues. In some embodiments, micro LED current may be controlled in the nano ampere level without sacrificing display quality or sacrificing speed due to settling times. In some embodiments, a pixel driving circuit consumes ultralow power.

In some embodiments, a digital pixel driving circuit is implemented using n channel Metal Oxide Semiconductor (nMOS) technology (for example, using nMOS transistors). In some embodiments, a digital pixel driving circuit using nMOS can provide, for example, low cost and/or low power requirements. In some embodiments, a digital pixel driving circuit is implemented using low-temperature polycrystalline silicon (LTPS) channel thin film transistors (TFTs). In some embodiments, a digital pixel driving circuit is implemented using indium gallium zinc oxide (IGZO) channel thin film transistors (TFTs).

In some embodiments, a circuit is used to receive an input current and create an LED driving current proportional to that voltage. In some embodiments, the width to length ratio of one or more transistors (for example, in some embodiments, the W/L ratio of one or more of transistors 102, 104, 106 and 108 of FIG. 1, and/or one or more of transistors 202, 204, 206 and 208 of FIG. 2, and/or one or more of transistors 302, 304, 306, 308, 310 and 312 of FIG. 3) may be adjusted to obtain a target driving current (for example, driving current I_{LED} in one or more of the embodiments described herein).

In some embodiments, multiple LEDs are arranged (for example, in parallel with each other) for each pixel in a display for fault tolerance purposes. Some embodiments relate to handling multiple LEDs (for example, multiple micro LEDs and/or multiple OLEDs) using one driver circuit. For example, in some embodiments, multiple redundant LEDs (for example, two or more LEDs) are arranged (for example in parallel) for each pixel in a display. In some embodiments, a driver circuit provides linear dependence of the current that is driving the LEDs based on the input current. In some embodiments, a current provided to one or more LEDs is linearly dependent on the input current.

In some embodiments, a driver circuit (for example, circuit 200 of FIG. 2 and/or circuit 300 of FIG. 3) handles multiple LEDs, and provides a driving current to each of those LEDs. In some embodiments, redundant LEDs (such as, for example, micro LEDs) may be implemented. For example, redundant LEDs may be used where those redundant LEDs together provide brightness for a single pixel (and/or single color for each pixel) in a display array of pixels (for example, a mobile display array of pixels and/or an LED display array of pixels). In this manner, redundant LEDs may be used to provide a fault tolerance relating to the LEDs and the current I_{LED} that is driving the LEDs based on the input current (for example, input current I₀). In this manner, if one LED is dead or not working for some reason, one or more other LEDs still provide the same amount of luminance that all of the LEDs would have together provided in parallel. While two redundant LEDs have been illustrated and described herein (for example, in FIG. 2 and/or in FIG. 3), according to some embodiments, one single LED could be used and current driven to that one single LED (for example, as illustrated in FIG. 1). Similarly, according to some embodiments, more than two LEDs could be used and current driven to those LEDs (for example, using more than two redundant LEDs). It is noted that embodiments are not limited to one LED or even two redundant LEDs as illustrated and described herein.

According to some embodiments, a true current mirror circuit is implemented with a scalable output current (that is, a scalable current through the load LED devices). In some embodiments, a true current mirror circuit provides a scalable output current through one or more LED devices (for example, in some embodiments micro LEDs and/or OLEDs).

Some embodiments relate to current programming of LED pixel drivers. According to some embodiments, programming LED pixels using current programming provides an advantage over voltage programming of pixels. For example, advantages can include compensation for current non-uniformities in active matrix flat panel display arrays such as, for example, AMLEDs (Active Matrix LEDs). However, for micro LED arrays, a small pixel current of 1 to 100 nA will result in a rather large pixel charging time in a current programming pixel. In order to reduce the pixel charging time, according to some embodiments, a large data current exceeding the desired LED current (for example, the desired micro LED current) is provided. In some embodiments, a current mirror is used to transfer the desired low current to the micro LED load. For example, in some embodiments as illustrated in FIG. 1, FIG. 2 and/or FIG. 3, some transistors can work together to operate as a current mirror.

According to some embodiments, current through LEDs (for example, current I_{LED}) can be controlled using a small W/L ratio for one or more of the transistors of the circuit, which results in a small area used for the circuit due to a small size of the transistors. According to some embodiments, current through LEDs (for example, current I_{LED}) can be controlled using a large bias current (for example a large bias current and/or input current I₀), resulting in a shorter settling time. For example, in some embodiments (for example, current driving circuits for driving one or more micro LEDs), a bias current and/or input current (for example, current I₀) in a range of approximately 10 to 20 μA (micro amps) can be used.

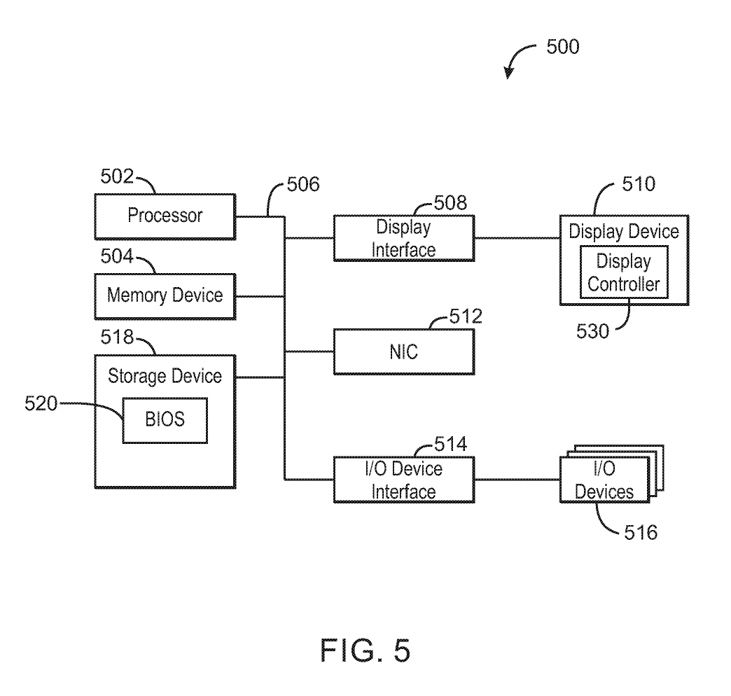

FIG. 5 is a block diagram of an example of a computing device 500 that can drive pixels in a display. In some embodiments, any portion of the circuits and/or systems illustrated in any one or more of FIGS. 1-4, and any of the embodiments described herein can be included in and/or be implemented by computing device 500. The computing device 500 may be, for example, a mobile phone, mobile device, handset, laptop computer, desktop computer, or tablet computer, among others. The computing device 500 may include a processor 502 that is adapted to execute stored instructions, as well as a memory device 504 (and/or storage device 504) that stores instructions that are executable by the processor 502. The processor 502 can be a single core processor, a multi-core processor, a computing cluster, or any number of other configurations. For example, processor 502 can be an Intel® processor such as an Intel® Celeron, Pentium, Core, Core i3, Core i5, or Core i7 processor. In some embodiments, processor 502 can be an Intel® x86 based processor. In some embodiments, processor 502 can be an ARM based processor. The memory device 504 can be a memory device and/or a storage device, and can include volatile storage, non-volatile storage, random access memory, read only memory, flash memory, or any other suitable memory or storage systems. The instructions that are executed by the processor 502 may also be used to implement display driver control as described in this specification.

The processor 502 may also be linked through the system interconnect 506 (e.g., PCI®, PCI-Express®, NuBus, etc.) to a display interface 508 adapted to connect the computing device 500 to a display device 510. The display device 510 may include a display screen that is a built-in component of the computing device 500. The display device 510 may also include a computer monitor, television, or projector, among others, that is externally connected to the computing device 500. The display device 510 can include light emitting diodes (LEDs), organic light emitting diodes (OLEDs), and/or micro-LEDs, among others.

In some embodiments, the display interface 508 can include any suitable graphics processing unit, transmitter, port, physical interconnect, and the like. In some examples, the display interface 508 can implement any suitable protocol for transmitting data to the display device 510. For example, the display interface 508 can transmit data using a high-definition multimedia interface (HDMI) protocol, a DisplayPort protocol, or some other protocol or communication link, and the like

In some embodiments, display device 510 includes a display controller 530. In some embodiments, the display controller 530 can provide control signals within and/or to the display device 510. In some embodiments, display controller 530 can be included in the display interface 508 (and/or instead of the display interface 508). In some embodiments, display controller 530 can be coupled between the display interface 508 and the display device 510. In some embodiments, the display controller 530 can be coupled between the display interface 508 and the interconnect 506. In some embodiments, the display controller 530 can be included in the processor 502. In some embodiments, display controller 530 can implement driving of display pixels as described herein (for example, as illustrated in and described in reference to any of the circuits and/or systems of FIGS. 1-4). In some embodiments, display controller 530 and/or display device 510 can include a display driver pixel system such as system 400 of FIG. 4. In some embodiments, a driver circuit (for example, such as driver circuit 100 of FIG. 1, driver circuit 200 of FIG. 2, and/or driver circuit 300 of FIG. 3) is provided for one or more pixel (or each pixel) in a display, and is included in display device 510 and/or display controller 530.

In addition, a network interface controller (also referred to herein as a NIC) 512 may be adapted to connect the computing device 500 through the system interconnect 506 to a network (not depicted). The network (not depicted) may be a cellular network, a radio network, a wide area network (WAN), a local area network (LAN), or the Internet, among others.

The processor 502 may be connected through system interconnect 506 to an input/output (I/O) device interface 514 adapted to connect the computing host device 500 to one or more I/O devices 516. The I/O devices 516 may include, for example, a keyboard and/or a pointing device, where the pointing device may include a touchpad or a touchscreen, among others. The I/O devices 516 may be built-in components of the computing device 500, or may be devices that are externally connected to the computing device 500.

In some embodiments, the processor 502 may also be linked through the system interconnect 506 to a storage device 518 that can include a hard drive, a solid state drive (SSD), a magnetic drive, an optical drive, a USB flash drive, an array of drives, or any other type of storage, including combinations thereof. In some embodiments, the storage device 518 can include any suitable applications. In some embodiments, the storage device 518 can include a basic input/output system (BIOS) 520.

It is to be understood that the block diagram of FIG. 5 is not intended to indicate that the computing device 500 is to include all of the components shown in FIG. 5. Rather, the computing device 500 can include fewer or additional components not illustrated in FIG. 5 (e.g., additional memory components, embedded controllers, additional modules, additional network interfaces, etc.). Furthermore, any of the functionalities of the BIOS 520 may be partially, or entirely, implemented in hardware and/or in the processor 502. For example, the functionality may be implemented with an application specific integrated circuit, logic implemented in an embedded controller, or in logic implemented in the processor 502, among others. In some embodiments, the functionalities of the BIOS 520 can be implemented with logic, wherein the logic, as referred to herein, can include any suitable hardware (e.g., a processor, among others), software (e.g., an application, among others), firmware, or any suitable combination of hardware, software, and firmware.

Reference in the specification to “one embodiment” or “an embodiment” or “some embodiments” of the disclosed subject matter means that a particular feature, structure, or characteristic described in connection with the embodiment is included in at least one embodiment of the disclosed subject matter. Thus, the phrase “in one embodiment” or “in some embodiments” may appear in various places throughout the specification, but the phrase may not necessarily refer to the same embodiment or embodiments.

### Example 1

In some examples, a light-emitting diode display driver system includes a digital pixel driver circuit. The digital pixel driver circuit is to receive an input current, to produce a current that is linearly dependent on the input current, and to provide the produced current to one or more light-emitting diodes.

### Example 2

In some examples, the system of EXAMPLE 1, where the one or more light-emitting diodes include a plurality of redundant light-emitting diodes. If any one or more of the redundant light-emitting diodes is not functional, the produced current is to be provided to one or more of the redundant light-emitting diodes that are functional. In some examples, the produced current is not to be provided to one or more of the redundant light-emitting diodes that are not functional.

### Example 3

In some examples, the system of EXAMPLE 1, where each or some of the one or more light-emitting diodes is a micro light-emitting diode, and/or where each or some of the one or more light-emitting diodes is an organic light-emitting diode.

### Example 4

In some examples, the system of EXAMPLE 1, where the digital pixel driver circuit includes a plurality of transistors.

### Example 5

In some examples, the system of EXAMPLE 4, where the digital pixel driver circuit is to convert the input current into the produced current using a multiplication factor that is dependent on one or more sizes of one or more of the transistors.

### Example 6

In some examples, the system of EXAMPLE 4, where the current to be provided is dependent on a size of one or more of the transistors.

### Example 7

In some examples, the system of EXAMPLE 4, where the current to be provided is dependent on a width to length ratio of one or more of the transistors.

### Example 8

In some examples, the system of EXAMPLE 4, where the transistors are nMOS transistors.

### Example 9

In some examples, the system of EXAMPLE 4, where the transistors are low-temperature polycrystalline silicon channel thin film transistors.

### Example 10

In some examples, the system of EXAMPLE 4, where the transistors are indium gallium zinc oxide channel thin film transistors.

### Example 11

In some examples, the system of EXAMPLE 4, where the transistors are to be operated in a strong inversion operating region.

### Example 12

In some examples, the system of EXAMPLE 1, where the input current is much larger than the current to be provided to the light-emitting diodes.

### Example 13

In some examples, the system of EXAMPLE 12, wherein the input current is in a micro ampere range, and the current to be provided to the light-emitting diodes is in a nano ampere range.

### Example 14

In some examples, the system of EXAMPLE 1, where the digital pixel driver circuit is to self-compensate for threshold voltage variation.

### Example 15

In some examples, the system of EXAMPLE 1, where the input current is large enough to maintain settling time.

### Example 16

In some examples, a light-emitting diode display driver system includes a plurality of digital pixel driver circuits. Each of the digital pixel driver circuits is to drive current for a respective pixel in the display driver system. At least one of the plurality of digital pixel driver circuits is to receive an input current, to produce a current that is dependent on the input current, and to provide the produced current to one or more light-emitting diodes corresponding to the respective pixel.

### Example 17

In some examples, the system of EXAMPLE 16, where two or more of the plurality of digital pixel driver circuits is to receive an input current, to produce a current that is linearly dependent on the input current, and to provide the produced current to one or more light-emitting diodes.

### Example 18

In some examples, the system of EXAMPLE 17, where a first of the two or more digital pixel driver circuits is to provide a first produced current to a first set of one or more light-emitting diodes. A second of the two or more digital pixel driver circuits is to provide a second produced current to a second set of one or more light-emitting diodes. The first produced current is different than the second produced current.

### Example 19

In some examples, the system of EXAMPLE 18, where the first set of one or more light-emitting diodes include light-emitting diodes of a first color and the second set of one or more light-emitting diodes include light-emitting diodes of a second color.

### Example 20

In some examples, the system of EXAMPLE 18, where the first of the two or more digital pixel driver circuits includes a first plurality of transistors and the second of the two or more digital pixel driver circuits includes a second plurality of transistors. The first produced current is dependent on a first width to length ratio of one or more of the first plurality of transistors. The second produced current is dependent on a second width to length ratio of one or more of the second plurality of transistors. The second width to length ratio is different than the first width to length ratio.

### Example 21

In some examples, the system of EXAMPLE 16, where the plurality of digital pixel driver circuits includes a plurality of red pixel driver circuits, a plurality of green pixel driver circuits, and a plurality of blue pixel driver circuits.

### Example 22

In some examples, the system of EXAMPLE 16, where each of the light-emitting diodes is a micro light-emitting diode, or each of the light-emitting diodes is an organic light-emitting diode, and/or each of the light-emitting diodes is either a micro light-emitting diode or an organic light-emitting diode.

### Example 23

In some examples, the system of EXAMPLE 16, where the at least one of the plurality of digital pixel driver circuits includes a plurality of transistors. The current to be provided is dependent on a width to length ratio of one or more of the plurality of transistors.

### Example 24

In some examples, the system of EXAMPLE 16, where the at least one of the plurality of digital pixel driver circuits includes one or more low-temperature polycrystalline silicon channel thin film transistors and/or includes one or more indium gallium zinc oxide channel thin film transistors.

### Example 25

In some examples, the system of EXAMPLE 16, where the input current is in a micro ampere range, and the current to be provided is in a nano ampere range.

### Example 26

In some examples, the system of EXAMPLE 16, where the at least one of the plurality of digital pixel driver circuits includes transistors to be operated in a strong inversion operating region.

### Example 27

In some examples, the system of EXAMPLE 16, where the at least one of the plurality of digital pixel driver circuits is to self-compensate for threshold voltage variation.

### Example 28

In some examples, the system of EXAMPLE 16, where the input current is large enough to maintain settling time.

### Example 29

In some examples, a light-emitting diode display driver system includes a digital pixel driver circuit. The digital pixel driver circuit is to receive an input current, to produce a current that is linearly dependent on the input current, and to provide the produced current to one or more light-emitting diodes.

### Example 30

In some examples, the system of EXAMPLE 29, where the one or more light-emitting diodes include a plurality of redundant light-emitting diodes. If any one or more of the redundant light-emitting diodes is not functional, the produced current is to be provided to one or more of the redundant light-emitting diodes that are functional.

### Example 31

In some examples, the system of EXAMPLE 29, where each of the one or more light-emitting diodes is either a micro light-emitting diode or an organic light-emitting diode.

### Example 32

In some examples, the system of EXAMPLE 29, where the input current is much larger than the current to be provided

### Example 33

In some examples, the system of EXAMPLE 32, where the input current is in a micro ampere range, and the current to be provided is in a nano ampere range.

### Example 34

In some examples, the system of EXAMPLE 29, where the digital pixel driver circuit is to self-compensate for threshold voltage variation.

### Example 35

In some examples, the system of EXAMPLE 29, where the input current is large enough to maintain settling time

### Example 36

In some examples, the system of any of EXAMPLES 29-35, where the digital pixel driver circuit includes a plurality of transistors.

### Example 37

In some examples, the system of EXAMPLE 36, where the digital pixel driver circuit is to convert the input current into the produced current using a multiplication factor that is dependent on one or more sizes of one or more of the transistors.

### Example 38

In some examples, the system of EXAMPLE 36, where the current to be provided is dependent on a size of one or more of the transistors.

### Example 39

In some examples, the system of EXAMPLE 36, where the current to be provided is dependent on a width to length ratio of one or more of the transistors.

### Example 40

In some examples, the system of EXAMPLE 36, where the transistors are nMOS transistors, the transistors are low-temperature polycrystalline silicon channel thin film transistors, and/or the transistors are indium gallium zinc oxide channel thin film transistors.

### Example 41

In some examples, the system of EXAMPLE 36, where the transistors are to be operated in a strong inversion operating region.

### Example 42

In some examples, a light-emitting diode display driver system includes a plurality of digital pixel driver circuits. Each of the digital pixel driver circuits is to drive current for a respective pixel in the display driver system. At least one of the plurality of digital pixel driver circuits is to receive an input current, to produce a current that is dependent on the input current, and to provide the produced current to one or more light-emitting diodes corresponding to the respective pixel.

### Example 43

In some examples, the system of EXAMPLE 42, where two or more of the plurality of digital pixel driver circuits is to receive an input current, to produce a current that is linearly dependent on the input current, and to provide the produced current to one or more light-emitting diodes.

### Example 44

In some examples, the system of EXAMPLE 43, where a first of the two or more digital pixel driver circuits is to provide a first produced current to a first set of one or more light-emitting diodes. A second of the two or more digital pixel driver circuits is to provide a second produced current to a second set of one or more light-emitting diodes. The first produced current is different than the second produced current.

### Example 45

In some examples, the system of EXAMPLE 44, where the first set of one or more light-emitting diodes includes light-emitting diodes of a first color and the second set of one or more light-emitting diodes includes light-emitting diodes of a second color.

### Example 46

In some examples, the system of EXAMPLE 44 or 45, where the first of the two or more digital pixel driver circuits includes a first plurality of transistors and the second of the two or more digital pixel driver circuits includes a second plurality of transistors. The first produced current is dependent on a first width to length ratio of one or more of the first plurality of transistors and the second produced current is dependent on a second width to length ratio of one or more of the second plurality of transistors. The second width to length ratio is different than the first width to length ratio.

### Example 47

In some examples, the system of any of EXAMPLES 42-45, where the plurality of digital pixel driver circuits includes a plurality of red pixel driver circuits, a plurality of green pixel driver circuits, and a plurality of blue pixel driver circuits.

### Example 48

In some examples, a light-emitting diode display driver system includes digital pixel driver means for receiving an input current and producing a current that is linearly dependent on the input current. The light-emitting diode display driver system also includes means for providing the produced current to one or more light-emitting diodes.

### Example 49

In some examples, the system of EXAMPLE 48, including means for converting the input current to the produced current in response to a multiplication factor that is dependent upon a size of transistors included in the digital pixel driver means.

### Example 50

In some examples, a display driver method includes receiving an input current, digitally producing a current that is linearly dependent on the input current, and providing the produced current to one or more light-emitting diodes.

### Example 51

In some examples, the method of EXAMPLE 50, including, if any one or more of the light-emitting diodes is not functional, providing the produced current to one or more of the light-emitting diodes that are functional.

### Example 52

In some examples, the method of EXAMPLE 50, where the input current is large enough to maintain settling time, and is much larger than the produced current.

### Example 53

In some examples, the method of any of EXAMPLES 50-52, including self-compensating for threshold voltage variation.

### Example 54

In some examples, a display driver method including receiving an input current, digitally producing a current that is linearly dependent on the input current, and providing the produced current to one or more light-emitting diodes.

### Example 55

In some examples, the method of EXAMPLE 54, including, if any one or more of the light-emitting diodes is not functional, providing the produced current to one or more of the light-emitting diodes that are functional.

### Example 56

In some examples, the method of EXAMPLE 54 or 55, where the one or more light-emitting diodes include one or more micro light-emitting diode and/or one or more organic light-emitting diode.

### Example 57

In some examples, the method of any of EXAMPLES 54-56, where the digitally producing is implemented using a plurality of transistors.

### Example 58

In some examples, the method of EXAMPLE 57, including digitally converting the input current into the produced current using a multiplication factor that is dependent on one or more sizes of one or more of the transistors.

### Example 59

In some examples, the method of EXAMPLE 57 or 58, where the current is to be provided is dependent on a size of one or more of the transistors, and/or where the current is to be provided is dependent on a width to length ratio of one or more of the transistors, and/or where the transistors are nMOS transistors, and/or where the transistors are low-temperature polycrystalline silicon channel thin film transistors, and/or where the transistors are indium gallium zinc oxide channel thin film transistors, and/or where the transistors are to be operated in a strong inversion operating region.

### Example 60

In some examples, the method of any of EXAMPLES 54-59, where the input current is large enough to maintain settling time, and/or where the input current is much larger than the current to be provided, and/or where the input current is in a micro ampere range and the current to be provided is in a nano ampere range.

### Example 61

In some examples, the method of any of EXAMPLES 54-60, including compensating for threshold voltage variation.

### Example 62

In some examples, the method of any of EXAMPLES 54-61, including for a plurality of pixels in the display receiving an input current that is the same or different than the input current received for other pixels, digitally producing a current for that pixel that is linearly dependent on the same or different input current, and providing the produced current for that pixel to a set of one or more light-emitting diodes corresponding to that pixel.

### Example 63

In some examples, the method of EXAMPLE 62, where the produced current for a first of the pixels is different than the produced current for a second of the pixels.

### Example 64

In some examples, the method of EXAMPLE 63, where the set of light-emitting diodes for the first of the pixels include light-emitting diodes of a first color and the set of light-emitting diodes for the second of the pixels include light-emitting diodes of a second color.

### Example 65

In some examples, the method of EXAMPLE 63 or 64, where the digitally producing for the first of the pixels includes a first plurality of transistors and the digitally producing for the second of the pixels includes a second plurality of transistors. The digitally produced current for the first pixel is dependent on a first width to length ratio of one or more of the first plurality of transistors. The digitally produced current for the second pixel is dependent on a second width to length ratio of one or more of the second plurality of transistors. The second width to length ratio is different than the first width to length ratio.

### Example 66

In some examples, the method of any of EXAMPLES 62-65, where the plurality of pixels includes a plurality of red pixels, a plurality of green pixels, and a plurality of blue pixels.

### Example 67

In some examples, an apparatus including means to perform a method as claimed in any preceding EXAMPLE.

### Example 68

In some examples, a light-emitting diode display system, includes one or more light-emitting diodes. A pixel driver circuit is to receive an input current, is to produce a current that is dependent on the input current, and is to provide the produced current to the one or more light-emitting diodes.

### Example 69

In some examples, the system of EXAMPLE 68, where the pixel driver circuit is an analog pixel driver circuit.

### Example 70

In some examples, the system of EXAMPLE 68, where the one or more light-emitting diodes includes a plurality of redundant light-emitting diodes.

If any one or more of the redundant light-emitting diodes is not functional, the current is to be provided to one or more of the redundant light-emitting diodes that are functional.

### Example 71

In some examples, the system of EXAMPLE 68, where each of the one or more light-emitting diodes is either a micro light-emitting diode or an organic light-emitting diode. All of the one or more light-emitting diodes may be a micro light-emitting diode. All of the one or more light-emitting diodes may be an organic light-emitting diode.

### Example 72

In some examples, the system of EXAMPLE 68, where the pixel driver circuit includes a plurality of transistors.

### Example 73

In some examples, the system of EXAMPLE 72, where the current to be provided is dependent on a size of one or more of the transistors.

### Example 74

In some examples, the system of EXAMPLE 72, where the current to be provided is dependent on a width to length ratio of one or more of the transistors.

### Example 75

In some examples, the system of EXAMPLE 72, where the transistors are pMOS transistors.

### Example 76

In some examples, the system of EXAMPLE 72, where the transistors are low-temperature polycrystalline silicon channel thin film transistors.

### Example 77

In some examples, the system of EXAMPLE 72, where the transistors are indium gallium zinc oxide channel thin film transistors.

### Example 78

In some examples, the system of EXAMPLE 72, where the transistors are to be operated in a strong inversion operating region.

### Example 79

In some examples, the system of EXAMPLE 68, where the input current is in a micro ampere range, and the current to be provided is in a nano ampere range.

### Example 80

In some examples, the system of EXAMPLE 68, where the pixel driver circuit is to self-compensate for threshold voltage variation.

### Example 81

In some examples, the system of EXAMPLE 68, where the input current is large enough to maintain circuit speed.

### Example 82

In some examples, the system of EXAMPLE 68, where the one or more light-emitting diodes each have a terminal that is coupled to a ground voltage.

### Example 83

In some examples, the system of EXAMPLE 68, where the pixel driver circuit includes a plurality of transistors and at least one capacitor. The pixel driver circuit is to use the at least one capacitor and one or more of the transistors to mirror current to the one or more light-emitting diodes in an analog fashion.

### Example 84

In some examples, a light-emitting diode display driver system, includes a plurality of pixel driver circuits to each drive current for a respective pixel in the display driver system. At least one of the plurality of pixel driver circuits is to receive an input current, and is to produce a current to be provided to one or more light-emitting diodes of the respective pixel that is dependent on the input current.

### Example 85

In some examples, the system of EXAMPLE 84, where the at least one pixel driver circuit is an analog pixel driver circuit.

### Example 86

In some examples, the system of EXAMPLE 84, where each of the plurality of pixel driver circuits is to receive an input current, and to produce a current to be provided to one or more light-emitting diodes. The produced current is dependent on the input current.

### Example 87

In some examples, the system of EXAMPLE 84, where the plurality of pixel driver circuits includes a plurality of red pixel driver circuits, a plurality of green pixel driver circuits, and a plurality of blue pixel driver circuits.

### Example 88

In some examples, the system of EXAMPLE 84, where each of the light-emitting diodes is one of a micro light-emitting diode or an organic light-emitting diode.

### Example 89

In some examples, the system of EXAMPLE 84, where the at least one of the plurality of pixel driver circuits includes a plurality of transistors. The current to be provided is dependent on a width to length ratio of one or more of the plurality of transistors.

### Example 90

In some examples, the system of EXAMPLE 84, where the at least one of the plurality of pixel driver circuits includes one or more pMOS transistors, one or more low-temperature polycrystalline silicon channel thin film transistors, and/or one or more indium gallium zinc oxide channel thin film transistors.

### Example 91

In some examples, the system of EXAMPLE 84, where the input current is in a micro ampere range, and the current to be provided is in a nano ampere range.

### Example 92

In some examples, the system of EXAMPLE 84, where the at least one of the plurality of pixel driver circuits includes transistors to be operated in a strong inversion operating region.

### Example 93

In some examples, the system of EXAMPLE 84, where the at least one of the plurality of pixel driver circuits is to self-compensate for threshold voltage variation.

### Example 94

In some examples, the system of EXAMPLE 84, where the input current is large enough to maintain circuit speed.

### Example 95

In some examples, the system of EXAMPLE 84, where the one or more light-emitting diodes each have a terminal that is coupled to a ground voltage.

### Example 96

In some examples, the system of EXAMPLE 84, where the at least one of the plurality of pixel driver circuits includes a plurality of transistors and at least one capacitor. The at least one pixel driver circuit is to use the at least one capacitor and one or more of the transistors to mirror current to the one or more light-emitting diodes in an analog fashion.

### Example 97

In some examples, a light-emitting diode display system includes one or more light-emitting diodes. The light-emitting diode display system also includes a pixel driver circuit to receive an input current, to produce a current that is dependent on the input current, and to provide the produced current to the one or more light-emitting diodes.

### Example 98

In some examples, the system of EXAMPLE 97, where the pixel driver circuit is an analog pixel driver circuit.

### Example 99

In some examples, the system of EXAMPLE 97, where the one or more light-emitting diodes include a plurality of redundant light-emitting diodes.

If any one or more of the redundant light-emitting diodes is not functional, the current is to be provided to one or more of the redundant light-emitting diodes that are functional.

### Example 100

In some examples, the system of EXAMPLE 97, where each of the one or more light-emitting diodes is one of a micro light-emitting diode or an organic light-emitting diode.

### Example 101

In some examples, the system of EXAMPLE 97, where the input current is in a micro ampere range, and the current to be provided is in a nano ampere range.

### Example 102

In some examples, the system of EXAMPLE 97, where the pixel driver circuit is to self-compensate for threshold voltage variation.

### Example 103

In some examples, the system of EXAMPLE 97, where the input current is large enough to maintain circuit speed.

### Example 104

In some examples, the system of EXAMPLE 97, where the one or more light-emitting diodes each have a terminal that is coupled to a ground voltage.

### Example 105

In some examples, the system of EXAMPLE 97, where the pixel driver circuit includes a plurality of transistors and at least one capacitor. The pixel driver circuit is to use the at least one capacitor and one or more of the transistors to mirror current to the one or more light-emitting diodes in an analog fashion.

### Example 106

In some examples, the system of any of EXAMPLES 97-105, where the pixel driver circuit includes a plurality of transistors.

### Example 107

In some examples, the system of EXAMPLE 106, where the current to be provided is dependent on a size of one or more of the transistors.

### Example 108

In some examples, the system of EXAMPLE 106, where the current to be provided is dependent on a width to length ratio of one or more of the transistors.

### Example 109

In some examples, the system of EXAMPLE 106, where the transistors are pMOS transistors, and/or where the transistors are low-temperature polycrystalline silicon channel thin film transistors, and/or where the transistors are indium gallium zinc oxide channel thin film transistors.

### Example 110

In some examples, the system of EXAMPLE 106, where the transistors are to be operated in a strong inversion operating region.

### Example 111

In some examples, a light-emitting diode display driver system, including a plurality of pixel driver circuits to each drive current for a respective pixel in the display driver system. At least one of the plurality of pixel driver circuits is to receive an input current, and is to produce a current to be provided to one or more light-emitting diodes of the respective pixel that is dependent on the input current.

### Example 112

In some examples, the system of EXAMPLE 111, where each of the plurality of pixel driver circuits is to receive an input current, and is to produce a current to be provided to one or more light-emitting diodes that is dependent on the input current.

### Example 113

In some examples, the system of EXAMPLE 111, where the plurality of pixel driver circuits includes a plurality of red pixel driver circuits, a plurality of green pixel driver circuits, and a plurality of blue pixel driver circuits.

### Example 114

In some examples, the system of EXAMPLE 97, where the one or more light-emitting diodes each have a terminal that is coupled to a ground voltage.

### Example 115

In some examples, the system of EXAMPLE 111, where the at least one of the plurality of pixel driver circuits includes a plurality of transistors and at least one capacitor. The at least one pixel driver circuit is to use the at least one capacitor and one or more of the transistors to mirror current to the one or more light-emitting diodes in an analog fashion.

### Example 116

In some examples, the system of any of EXAMPLES 111-115, where the at least one of the plurality of pixel driver circuits includes a plurality of transistors. The current to be provided is dependent on a width to length ratio of one or more of the plurality of transistors.

### Example 117

In some examples, a light-emitting diode display driver system including one or more light-emitting diodes, analog pixel driver means for receiving an input current and producing a current that is dependent on the input current, and means for providing the produced current to the one or more light-emitting diodes.

### Example 118

In some examples, the system of EXAMPLE 117, including means for converting the input current to the produced current in response to a factor that is dependent upon a size of transistors included in the analog pixel driver means.

### Example 119

In some examples, the system of any of EXAMPLES 117-118, including means for mirroring current to the one or more light-emitting diodes in an analog fashion.

### Example 120

In some examples, a method for driving current to one or more light-emitting diodes, including receiving an input current, producing a current that is dependent on the input current, and providing the produced current to the one or more light-emitting diodes.

### Example 121

In some examples, the method of EXAMPLE 120, including mirroring current to the one or more light-emitting diodes in an analog fashion.

### Example 122

In some examples, a method of driving current to one or more light-emitting diodes in a display, including receiving an input current, producing a current that is dependent on the input current, and providing the produced current to the one or more light-emitting diodes.

### Example 123

In some examples, the method of EXAMPLE 122, including producing the current in an analog fashion, and/or mirroring current in an analog fashion, and/or mirroring current in an analog fashion using at least one capacitor and one or more transistors.

### Example 124

In some examples, the method of any of EXAMPLES 122-123, where the one or more light-emitting diodes include a plurality of redundant light-emitting diodes. If any one or more of the redundant light-emitting diodes is not functional, the method includes providing the current to one or more of the redundant light-emitting diodes that are functional.

### Example 125

In some examples, the method of any of EXAMPLES 122-124, where each of the one or more light-emitting diodes is one of a micro light-emitting diode or an organic light-emitting diode.

### Example 126

In some examples, the method of any of EXAMPLES 122-125, including using a plurality of transistors to produce the current that is dependent on the input current.

### Example 127

In some examples, the method of EXAMPLE 126, where the produced current is dependent on a size of one or more of the transistors.

### Example 128

In some examples, the method of any of EXAMPLES 126-127, where the produced current is dependent on a width to length ratio of one or more of the transistors.

### Example 129

In some examples, the method of any of EXAMPLES 126-128, where the transistors are pMOS transistors, and/or where the transistors are low-temperature polycrystalline silicon channel thin film transistors, and/or where the transistors are indium gallium zinc oxide channel thin film transistors.

### Example 130

In some examples, the method of any of EXAMPLES 126-129, including operating the transistors in a strong inversion operating region.

### Example 131

In some examples, the method of any of EXAMPLES 122-130, where the input current is in a micro ampere range, and the current to be provided is in a nano ampere range.

### Example 132

In some examples, the method of any of EXAMPLES 122-131, including self-compensating for threshold voltage variation.

### Example 133

In some examples, the method of any of EXAMPLES 122-132, wherein the input current is large enough to maintain circuit speed.

### Example 134

In some examples, the method of any of EXAMPLES 122-133, where the one or more light-emitting diodes each have a terminal that is coupled to a ground voltage.

### Example 135

In some examples, the method of any of EXAMPLES 122-134, including for each of a plurality of pixels in the display, receiving an input current, producing a current that is dependent on the input current, and providing the produced current to a corresponding group of one or more light-emitting diodes corresponding to that pixel.

### Example 136

In some examples, an apparatus comprising means to perform a method as claimed in any preceding EXAMPLE.

Although an example embodiment of the disclosed subject matter is described with reference to circuit and block diagrams in the drawings, persons of ordinary skill in the art will readily appreciate that many other ways of implementing the disclosed subject matter may alternatively be used. For example, the order of execution of the blocks in flow diagrams may be changed, and/or some of the blocks in block/flow diagrams described may be changed, eliminated, or combined. Additionally, some of the circuit elements may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

Program code may represent hardware using a hardware description language or another functional description language which essentially provides a model of how designed hardware is expected to perform. Program code may be assembly or machine language or hardware-definition languages, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, one or more volatile and/or non-volatile memory devices, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter. For example, in each illustrated embodiment and each described embodiment, it is to be understood that the diagrams of the figures and the description herein is not intended to indicate that the illustrated or described devices include all of the components shown in a particular figure or described in reference to a particular figure. In addition, each element may be implemented with logic, wherein the logic, as referred to herein, can include any suitable hardware (e.g., a processor, among others), software (e.g., an application, among others), firmware, or any suitable combination of hardware, software, and firmware, for example.

What is claimed is:

1. A light-emitting diode display system, comprising:
one or more light-emitting diodes; and
a pixel driver circuit to receive an input current, to produce a current that is dependent on the input current, and to provide the produced current to the one or more light-emitting diodes.

2. The system of claim 1, wherein the pixel driver circuit is an analog pixel driver circuit.

3. The system of claim 1, wherein the one or more light-emitting diodes comprise a plurality of redundant light-emitting diodes, wherein if any one or more of the redundant light-emitting diodes is not functional, the current is to be provided to one or more of the redundant light-emitting diodes that are functional.

4. The system of claim 1, wherein each of the one or more light-emitting diodes is one of a micro light-emitting diode or an organic light-emitting diode.

5. The system of claim 1, wherein the pixel driver circuit includes a plurality of transistors.

6. The system of claim 5, wherein the current to be provided is dependent on a size of one or more of the transistors.

7. The system of claim 5, wherein the current to be provided is dependent on a width to length ratio of one or more of the transistors.

8. The system of claim 5, wherein the transistors are pMOS transistors.

9. The system of claim 5, wherein the transistors are low-temperature polycrystalline silicon channel thin film transistors.

10. The system of claim 5, wherein the transistors are indium gallium zinc oxide channel thin film transistors.

11. The system of claim 5, wherein the transistors are to be operated in a strong inversion operating region.

12. The system of claim 1, wherein the input current is in a micro ampere range, and the current to be provided is in a nano ampere range.

13. The system of claim 1, wherein the pixel driver circuit is to self-compensate for threshold voltage variation.

14. The system of claim 1, wherein the input current is large enough to maintain circuit speed.

15. The system of claim 1, wherein the one or more light-emitting diodes each have a terminal that is coupled to a ground voltage.

16. The system of claim 1, wherein the pixel driver circuit includes a plurality of transistors and at least one capacitor, wherein the pixel driver circuit is to use the at least one capacitor and one or more of the transistors to mirror current to the one or more light-emitting diodes in an analog fashion.

17. A light-emitting diode display driver system, comprising:
a plurality of pixel driver circuits to each drive current for a respective pixel in the display driver system, at least one of the plurality of pixel driver circuits to receive an input current, and to produce a current to be provided to one or more light-emitting diodes of the respective pixel that is dependent on the input current.

18. The system of claim 17, wherein the at least one pixel driver circuit is an analog pixel driver circuit.

19. The system of claim 17, each of the plurality of pixel driver circuits to receive an input current, and to produce a current to be provided to one or more light-emitting diodes that is dependent on the input current.

20. The system of claim 17, wherein the plurality of pixel driver circuits includes a plurality of red pixel driver circuits, a plurality of green pixel driver circuits, and a plurality of blue pixel driver circuits.

21. The system of claim 17, wherein each of the light-emitting diodes is one of a micro light-emitting diode or an organic light-emitting diode.

22. The system of claim 17, wherein the at least one of the plurality of pixel driver circuits includes a plurality of transistors, and the current to be provided is dependent on a width to length ratio of one or more of the plurality of transistors.

23. The system of claim 17, wherein the at least one of the plurality of pixel driver circuits includes one or more pMOS transistors, one or more low-temperature polycrystalline silicon channel thin film transistors, or one or more indium gallium zinc oxide channel thin film transistors.

24. The system of claim 17, wherein the input current is in a micro ampere range, and the current to be provided is in a nano ampere range.

25. The system of claim 17, wherein the at least one of the plurality of pixel driver circuits includes transistors to be operated in a strong inversion operating region.

26. The system of claim 17, wherein the at least one of the plurality of pixel driver circuits is to self-compensate for threshold voltage variation.

27. The system of claim 17, wherein the input current is large enough to maintain circuit speed.

28. The system of claim 17, wherein the one or more light-emitting diodes each have a terminal that is coupled to a ground voltage.

29. The system of claim 17, wherein the at least one of the plurality of pixel driver circuits includes a plurality of transistors and at least one capacitor, wherein the at least one pixel driver circuit is to use the at least one capacitor and one or more of the transistors to mirror current to the one or more light-emitting diodes in an analog fashion.
